(19) United States
(12) Patent Application Publication
(10) Pub. No.: US 2025/0065872 A1
(43) Pub. Date: Feb. 27, 2025

(54) DRIVER ASSISTANCE METHOD AND DRIVER ASSISTANCE SYSTEM

(71) Applicant: HL Klemove Corp., Incheon (KR)

(72) Inventor: Hyunsoo Park, Seoul (KR)

(21) Appl. No.: 18/513,689

(22) Filed: Nov. 20, 2023

(30) Foreign Application Priority Data
Aug. 22, 2023 (KR) 10-2023-0110060

(51) Int. Cl. B60W 30/14; B60W 30/18

(52) U.S. Cl. CPC B60W 30/146; B60W 30/18159; B60W 2420/403; B60W 2520/105; B60W 2552/53; B60W 2555/60

(57) ABSTRACT

A driver assistance method and driver assistance system are provided. The driver assistance method may comprise: determining a driving state of a vehicle in a cruise control; recognizing a sign indicating a driving direction of a lane in which the vehicle is driving and a stop line at an intersection; confirming an intention of a driver to drive in a same direction as the driving direction of the lane indicated by the sign; and controlling a speed of the vehicle to be a predetermined safe speed if it is confirmed that the driver intends to drive in the same direction as the driving direction of the lane indicated by the sign.

### CROSS-REFERENCE TO RELATED APPLICATION

This application claims the benefit of and priority to Korean Patent Application No. 2023-0110060 filed on Aug. 22, 2023, the entire disclosures of which are incorporated herein by reference.

### TECHNICAL FIELD

The present disclosure relates to a driver assistance method and a driver assistance system. More specifically, the present disclosure relates to a driver assistance method and driver assistance system for controlling a speed of a vehicle to be a safe speed in case of driving along a specific driving path at an intersection while driving in a cruise control mode.

### BACKGROUND

In a vehicle, a driver assistance system provides assistance to a driver driving in the vehicle for the driver's convenience.

Among the driver assistance systems, a cruise control system is a technology of driving at a constant driving speed, while if a target vehicle is detected in front, the speed of the vehicle is controlled at a constant interval based on the distance to the target vehicle.

This cruise control may also be called as Active Cruise Control (ACC), Adaptive Cruise Control (ACC), Smart Cruise Control (SCC), Advanced Smart Cruise Control (ASCC), Dynamic Radar Cruise Control (DRCC).

On the other hand, according to the existing cruise control technology, if the target vehicle in front makes a left or right turn while following the target vehicle in front and the target vehicle in front disappears from the control target, the ego vehicle accelerates and the driver's anxiety increases.

In addition, in the above situation, if the difference between the set speed of the cruise control and the speed of the ego vehicle is large, the magnitude of acceleration increases, so there is a risk of a collision with the vehicle in front when turning left or right.

Accordingly, there is a need for a driver assistance method and a driver assistance system capable of further improving the safety by appropriately coping with changes in driving conditions when the vehicle drives in the cruise control mode.

### SUMMARY

The present disclosure is to solve the above-described problems of the prior art, and the object of the present disclosure is to provide a driver assistance method and a driver assistance system for assisting a driver to drive with a sense of stability when driving at an intersection while driving in a cruise control mode.

However, the technical problem to be achieved by the embodiments of the present application is not limited to the technical problems described above, and other technical problems may exist.

As a technical means for achieving the above technical problem, a driver assistance method according to an embodiment of the present disclosure comprises: determining a driving state of a vehicle in a cruise control; recognizing a sign indicating a driving direction of a lane in which the vehicle is driving and a stop line at an intersection; confirming an intention of a driver to drive in a same direction as the driving direction of the lane indicated by the sign; and controlling a speed of the vehicle to be a predetermined safe speed if it is confirmed that the driver intends to drive in the same direction as the driving direction of the lane indicated by the sign.

Further, the confirming of the intention of the driver may comprise determining whether the driving direction of the lane indicated by the sign indicating the driving direction of the lane matches with a direction of a turn signal light which is on.

Further, the confirming of the intention of the driver may further comprise determining whether an absolute value of a difference between a left side lateral offset value of the vehicle and a right side lateral offset value of the vehicle is less than a predetermined threshold value.

Further, the determining of the driving state may comprise determining whether the cruise control of the vehicle is activated.

Further, the determining of the driving state may further comprise determining whether the speed of the vehicle is equal to or less than a set speed of the cruise control if the cruise control is activated.

Further, if both of left and right turn signal lights of the vehicle are turned on, it may be determined that the driving direction indicated by the sign indicating the driving direction of the lane does not match with the direction of the turn signal light which is on.

Further, the sign indicating the driving direction of the lane and the stop line at the intersection may be recognized by a front camera installed at the vehicle.

The driver assistance method may further comprise: before controlling the speed of the vehicle, recognizing, by the front camera, a curvature of a guidance line guided by the lane in which the vehicle is driving; and setting the predetermined safe speed to be inversely proportional to the curvature of the guidance line recognized by the front camera.

Further, the controlling of the speed of the vehicle may further comprise: determining whether the speed of the vehicle is equal to the predetermined safe speed; and if the speed of the vehicle is not equal to the predetermined safe speed, controlling the vehicle according to a required acceleration of the vehicle by determining the required acceleration.

Further, the controlling of the vehicle according to the required acceleration may comprise determining the required acceleration of the vehicle based on a distance from the vehicle to the stop line at the intersection until the vehicle reaches the stop line.

Further, the controlling of the vehicle according to the required acceleration may comprise determining the required acceleration of the vehicle based on a difference between the predetermined safe speed and the speed of the vehicle after the vehicle passes the stop line at the intersection.

A driving assistance system according to an embodiment of the present disclosure comprises: a processor configured to determine a driving state of a vehicle in a cruise control; a recognition device configured to recognize a sign indicating a driving direction of a lane in which the vehicle is driving and a stop line at an intersection; a vehicle speed sensor configured to detect a speed of the vehicle on driving; and a controller configured to confirm an intention of a driver to drive in a same direction as the driving direction of the lane indicated by the sign, and if it is confirmed that the driver intends to drive in the same direction as the driving direction of the lane indicated by the sign, control the speed of the vehicle to be a predetermined safe speed.

Further, the recognition device may be a front camera installed at the vehicle.

The driving assistance system may further comprise a turn signal light sensor configured to detect whether a turn signal light of the vehicle is on, wherein the controller may be configured to receive a detection signal of the turn signal light of the vehicle from the turn signal light sensor, and determine whether the driving direction indicated by the sign indicating the driving direction of the lane matches with the direction of the turn signal light which is on.

Further, if the driving direction indicated by the sign indicating the driving direction of the lane matches with the direction of the turn signal light which is on, the controller may be configured to determine whether an absolute value of a difference between a left side lateral offset value of the vehicle and a right side lateral offset value of the vehicle is less than a predetermined threshold value.

Further, if the turn signal light sensor detects that both of the left and right turn signal lights of the vehicle are on, the controller may be configured to determine that the driving direction indicated by the sign indicating the driving direction of the lane does not match with the direction of the turn signal light which is on.

Further, the front camera may be configured to recognize a curvature of a guidance line guided by the lane in which the vehicle is driving, and the controller may be configured to determine the predetermined safe speed to be inversely proportional to a size of the curvature of the guidance line recognized by the front camera.

Further, the controller may be configured to determine whether the speed of the vehicle is equal to the predetermined safe speed, and if the speed of the vehicle is not equal to the predetermined safe speed, the controller may be configured to control the vehicle according to a required acceleration of the vehicle by determining the required acceleration.

Further, the controller may be configured to determine the required acceleration of the vehicle based on a distance from the vehicle to the stop line at the intersection until the vehicle reaches the stop line at the intersection.

Further, the controller may be configured to determine the required acceleration of the vehicle based on a difference between the predetermined safe speed and the speed of the vehicle after the vehicle passes the stop line at the intersection.

The above-described means for solving the problem is only exemplary and should not be construed as limiting the present disclosure. In addition to the exemplary embodiments described above, additional embodiments may exist in the drawings and detailed description of the present disclosure.

According to the above-described problem-solving means of the present disclosure, it is possible to provide a driver assistance method and a driver assistance system capable of more accurately determining a turning situation at an intersection and controlling a speed of a vehicle based on a safe driving speed so that the driver can drive with a sense of stability.

Further, according to the present disclosure, it is possible to provide a driver assistance method and a driver assistance system capable of providing convenience to a driver by preventing unnecessary release of the cruise control in the turning situation at the intersection.

However, the effects obtainable from the present disclosure are not limited to the effects described above, and other effects may exist.

### BRIEF DESCRIPTION OF THE DRAWINGS

FIG. 1 is a control flowchart illustrating a driver assistance method according to embodiments of the present disclosure.

FIG. 2 is a flowchart specifically illustrating the determining of the driving state in the cruise control of the vehicle, in the control flowchart of the driver assistance method according to the embodiment of the present disclosure.

FIG. 3 is a flowchart specifically illustrating the confirming of the intention of the driver, in the control flowchart of the driver assistance method according to the embodiment of the present disclosure.

FIG. 4 is a flowchart specifically illustrating the controlling of the speed of the vehicle, in the control flowchart of the driver assistance method according to the embodiment of the present disclosure.

FIG. 5 is a control diagram schematically illustrating a configuration of a driver assistance system according to embodiments of the present disclosure.

FIG. 6 is a diagram schematically illustrating a road environment when the vehicle enters an intersection in the driver assistance method according to the embodiment of the present disclosure.

FIG. 7A is a diagram illustrating a state of the vehicle before the vehicle reaches a stop line at an intersection in the driver assistance method according to the embodiment of the present disclosure, and FIG. 7B illustrates a state of the vehicle after the vehicle passes the stop line at the intersection in the driver assistance method according to the embodiment of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a driver assistance method and driver assistance system for determining a driving state at an intersection and performing a cruise control according to the driving state.

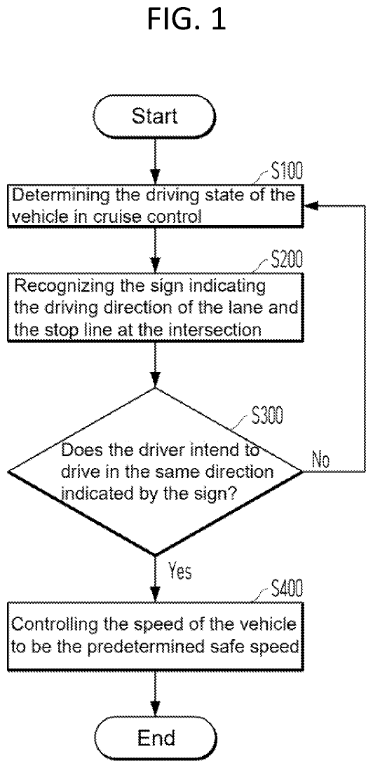

FIG. 1 is a control flowchart illustrating a driver assistance method according to embodiments of the present disclosure.

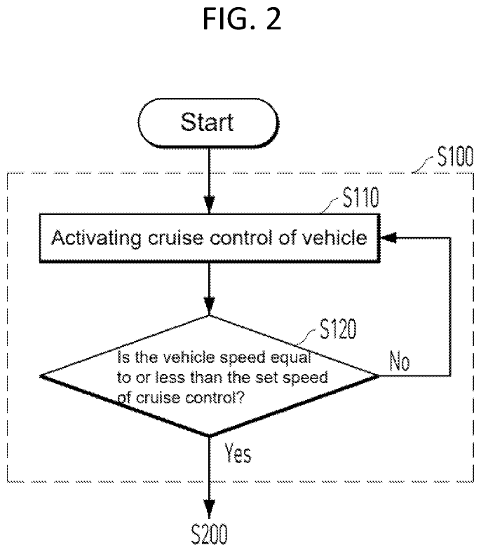

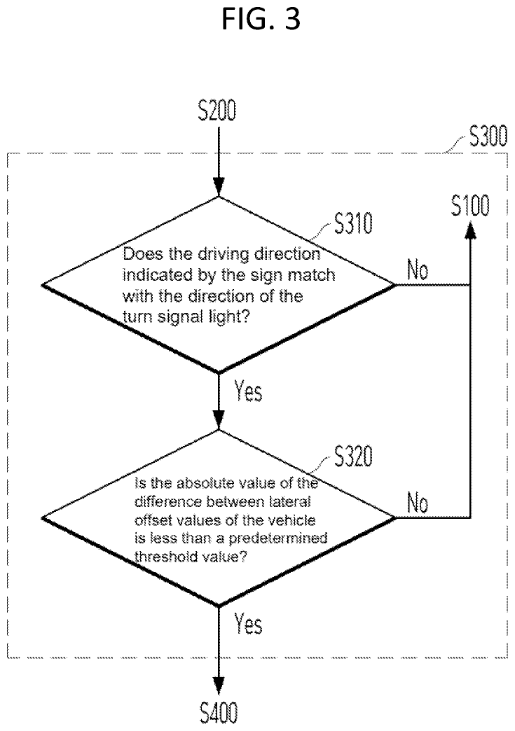

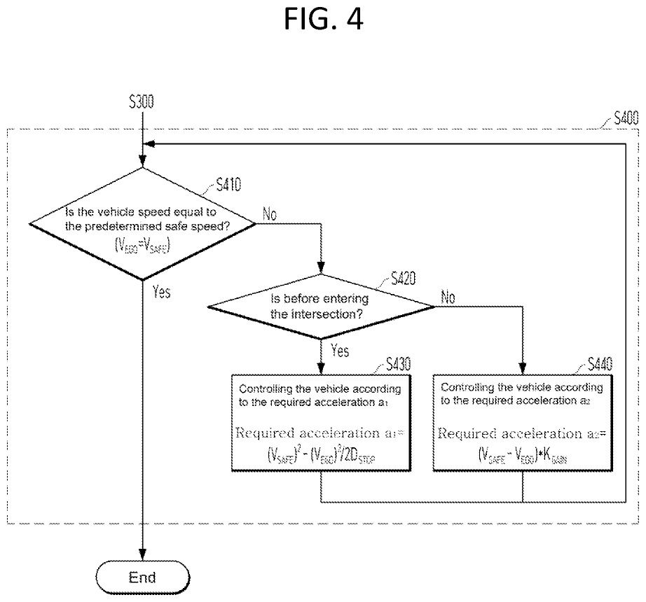

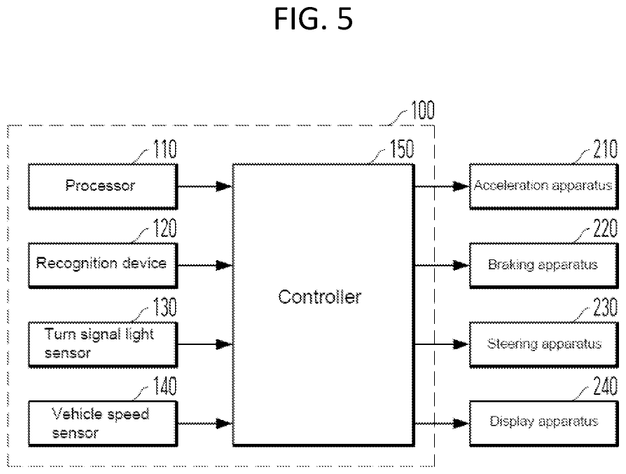

Further, in the control flowchart of the driver assistance method according to the embodiment of the present disclosure, FIG. 2 is a flowchart specifically illustrating the determining of the driving state in the cruise control of the vehicle, and FIG. 3 is a flowchart specifically illustrating the confirming of the intention of the driver, and FIG. 4 is a flowchart specifically illustrating the controlling of the speed of the vehicle.

First, referring to FIG. 1 of the present disclosure, the driver assistance method according to the embodiment of the present disclosure may include determining a driving state in a cruise control of the vehicle S100.

More specifically, the determining of the driving state in the cruise control of the vehicle S100 may include activating the cruise control of the vehicle S110 and determining whether the set speed of the cruise control is equal to or less than the speed of the vehicle S120 (see FIG. 2).

In this regard, the purpose of the present disclosure is to solve the problem of acceleration of the vehicle driving in the cruise control mode when turning left or right. If the cruise control of the vehicle is not activated, the control of the vehicle according to the driver assistance method of the present disclosure may not be performed, and if the speed of the vehicle exceeds the set speed of the cruise control (‘No’ in S120), the control of the vehicle according to the driver assistance method of the present disclosure may not be performed either.

Subsequently, according to the embodiment of the present disclosure, in determining the driving state in the cruise control of the vehicle S100, if it is determined that the cruise control of the vehicle is activated and the speed of the vehicle is equal to or less than the set speed of the cruise control, the recognizing of the sign indicating the driving direction of the lane and the stop line at the intersection S200 may be performed (see FIG. 1).

The sign indicating the driving direction of the lane may be, for example, a road mark by which the driving direction upon entering the intersection is indicated by an arrow on the lane on which the vehicle is driving before entering the intersection. However, the sign is not limited to the above, and any direction sign that can be recognized by a vehicle before entering an intersection may correspond to the sign indicating the driving direction of the lane in the present disclosure.

Further, the stop line at the intersection may refer to a line drawn in a vertical direction of the lane before entering the intersection. The stop line may be located in front of the crosswalk or behind the crosswalk at the intersection, or the stop line may exist without the crosswalk.

In addition, in the embodiment of the present disclosure, the sign indicating the driving direction of the lane and the stop line at the intersection may be recognized using, for example, a front camera installed at a windshield of the vehicle. That is, by obtaining the front image data of the vehicle by the front camera, it is possible to determine whether the driving situation of the vehicle is an intersection driving situation by recognizing the sign indicating the driving direction of the lane and the stop line at the intersection.

According to the prior art, the intersection driving situation was determined by the yaw rate and yaw acceleration values. However, determining the driving situation using only the information on the yaw rate and yaw acceleration values has limitations in accurately classifying the driving situation. For example, even in a non-intersection situation, there may be a case where the yaw rate and yaw acceleration values are the same as those in the intersection situation.

However, according to the present disclosure, since it is determined whether the vehicle is driving at the intersection by a sign indicating the driving direction of the lane and/or the stop line information of the intersection based on the information recognized by the front camera, it is possible to determine the intersection situation more accurately.

Further, according to the embodiment of the present application, after recognizing the sign indicating the driving direction of the lane and the stop line at the intersection, the determining of the intention of the driver S300 may be performed, in which it is determined whether the driver intends to drive in the same direction as the driving direction indicated by the sign indicating the driving direction of the lane. (see FIG. 1).

In other words, since the purpose of the present application is to control the speed of the vehicle in a situation where the driver makes a left or right turn at an intersection, it is required to confirm the driver's intention as to whether he or she intends to turn left or right.

Therefore, the speed control according to the embodiment of the present disclosure may not be performed in situations such as driving straight or making a U-turn rather than turning left or right at the intersection.

Looking at the determining of the intention of the driver in more detail, as shown in FIG. 3, the determining of the intention of the driver according to the embodiment of the present disclosure may include determining whether the driving direction indicated by the sign matches with the direction of a turn signal light which is on S310.

For example, if the vehicle is located in a left turn lane and the sign indicating the driving direction is recognized as an arrow indicating the left turn, and the driver turns on the left side turn signal, it may be determined that the driver has an intention of turning left at the intersection.

On the other hand, if it is determined that the direction of the sign indicating the driving direction and the direction of the turn signal light are not the same, it may be determined that the driver does not have the intention to turn left or right (‘No’ in S310), and the speed control of the vehicle according to the present disclosure may not be performed.

In this regard, if both of the left and the right turn signal lights are on, it may be determined that the sign indicating the driving direction does not match with the direction of the turn signal light, and if none of the turn signal lights are on, it may also be determined as unmatched. Accordingly, if both of the turn signals are turned on or none of the turn signals is turned on, the speed control of the vehicle according to the embodiment of the present disclosure may not be performed.

In addition, as shown in FIG. 3, the determining of the intention of the driver S300 according to the embodiment of the present disclosure may include determining whether the absolute value of the difference between the left side lateral offset value and the right side lateral offset value of the vehicle is less than a predetermined threshold value S320.

Specifically, the difference between the left and right side lateral offset values of the vehicle may indicate whether the vehicle is driving in the center of the lane in which the vehicle is driving. That is, if the vehicle is driving exactly in the center of the lane, the difference between the left and right side lateral offset values becomes 0, and the absolute value of the difference between the left and right side lateral offset values increases as the vehicle leans toward one side of the lane.

The difference between the lateral offset values of the vehicle may be used to determine the intention of the driver regarding whether the driver maintains the driving lane, that is, whether the driver maintains the left turn lane or the right turn lane before entering the intersection to make a left turn or right turn after entering the intersection.

For example, if the vehicle makes a U-turn before entering an intersection or changes the lane from the driving lane to a neighboring lane, the difference between left and right side lateral offset values may be equal to or greater than the predetermined threshold value. In this case, since it may be determined that the driver has no intention to maintain the driving lane before entering the intersection, there may be no intention of the driver to drive in the same direction as the driving direction indicated by the sign on the lane.

Accordingly, in step S320, it may determined whether the absolute value of the difference between the left side lateral offset value and the right side lateral offset value is less than a predetermined threshold value. Only if it is less than the predetermined threshold value, it may be determined that the driver has the intention to drive in the same direction as the driving direction indicated by the sign, and the speed of the vehicle may be controlled according to the embodiment of the present disclosure.

Subsequently, according to the embodiment of the present disclosure, if it is determined that the driver has the intention to drive in the same direction as the driving direction indicated by the sign, the controlling of the vehicle may be performed such that the speed of the vehicle becomes a predetermined safe speed S400.

Here, the safe speed V_{SAFE} of the vehicle may be a predetermined value, and may be set to, for example, a value inversely proportional to a curvature of a guidance line (i.e., proportional to a radius of the curvature) guided by the driving lane of the vehicle. The safe speed V_{SAFE} of the vehicle may be a tuning parameter that divides the curvature of the guidance line into a plurality of sections and is mapped for each section.

Therefore, in the driver assistance method according to the embodiment of the present disclosure, prior to the control step S400, determining the safe speed V_{SAFE} to be inversely proportional to the curvature of the guidance line may be further included by additionally recognizing the guidance line guided by the driving lane by the front camera installed at the vehicle, and by confirming the curvature of the guidance line.

Alternatively, as another embodiment, prior to entering the intersection, curvature information of the left turn or right turn of the intersection may be received through the GPS, and the safe speed V_{SAFE} of the vehicle may be determined based on the curvature information of the intersection obtained therefrom.

Looking at the control step according to the embodiment of the present disclosure in more detail with reference to FIG. 4, it may be determined first whether the speed of the vehicle (ego vehicle) V_{EGO} on driving is the same as the predetermined safe speed V_{SAFE} S410.

If it is determined in step S410 that the speed of the vehicle is the same as the predetermined safe speed (‘Yes’ in S410), an additional control of the vehicle speed may not be required.

On the other hand, if it is determined in step S410 that the speed of the vehicle is not the same as the predetermined safe speed (‘No’ in S410), it may be determined whether the vehicle is before entering the intersection S420.

Meanwhile, whether the vehicle has entered the intersection may be determined based on the stop line at the intersection. That is, before passing the stop line at the intersection, it may be determined as before entering the intersection, and after passing the stop line at the intersection, it may be determined as after entering the intersection.

If it is determined in step S420 that the vehicle is before entering the intersection, the vehicle may be controlled according to the requested acceleration a₁.

Specifically, the requested acceleration a₁ may be expressed by the following equation.

$$Required Acceleration {a}_{1} = {( {V}_{SAFE} )}^{2} - {( {V}_{EGO} )}^{2} / 2 {D}_{STOP} \qquad [ Equation 1 ]$$

Here, V_{SAFE} may refer to the predetermined safe speed, V_{EGO} may refer to the vehicle speed, and D_{STOP} may refer to the distance from the vehicle to the stop line.

That is, before the vehicle enters the intersection (before passing the stop line), the required acceleration a₁ of the vehicle may be determined based on the distance from the vehicle to the stop line D_{STOP}, and the vehicle may be controlled according to the determined required acceleration a₁.

Meanwhile, if it may be determined in step S420 that the vehicle has entered the intersection, the vehicle may be controlled according to the requested acceleration a₂.

Specifically, the requested acceleration a₂ may be expressed by the following equation.

$$Required Acceleration {a}_{2} = ( {V}_{SAFE} - {V}_{EGO} ) * {K}_{GAIN} \qquad [ Equation 2 ]$$

Here, V_{SAFE} may refer to the predetermined safe speed, V_{EGO} may refer to the vehicle speed, and K_{GAIN} may refer to a preset parameter value.

That is, after the vehicle enters the intersection (after passing the stop line), the required acceleration a₂ of the vehicle may be determined based on the difference between the predetermined safe speed V_{SAFE} and the vehicle speed V_{EGO}, and the vehicle may be controlled according to the determined required acceleration a₂.

The control of the vehicle according to the requested acceleration a₁ and the requested acceleration a₂ as described above may be performed until the speed V_{EGO} of the ego vehicle becomes equal to the predetermined safe speed V_{SAFE}.

As described above, according to the driver assistance method according to the embodiment of the present disclosure, when the vehicle makes a left turn or a right turn at an intersection while driving in a cruise control mode, the speed of the vehicle may be controlled based on the safe speed. By doing so, it is possible to reduce the possibility of collision as well as provide the driver with a sense of psychological stability.

FIG. 5 is a control diagram schematically illustrating a configuration of a driver assistance system according to embodiments of the present disclosure.

Referring to FIG. 5, the driver assistance system 100 according to the embodiment of the present disclosure may include: a processor 110 configured to determine a cruise control driving state of the vehicle; a recognition device 120 configured to recognize a sign indicating a driving direction of a lane in which the vehicle is driving and a stop line at an intersection; a turn signal light sensor 130 configured to detect whether a turn signal is turned on; a vehicle speed sensor 140 configured to detect a speed of the vehicle on driving; and a controller 150 configured to control the speed of the vehicle. Meanwhile, the recognition device 120 may be a front camera installed at the vehicle.

The controller 150 may confirm whether the cruise control of the vehicle is activated and confirm the set speed of the cruise control of the vehicle from the driving state processor 110, and may determine whether the speed of the vehicle received from the vehicle speed sensor 140 is equal to or less than the cruise control set speed.

Further, the controller 150 may confirm the intention of the driver to drive in the same direction as the driving direction of the lane indicated by the sign. If it is determined that the driver intends to drive in the same direction as the driving direction of the lane indicated by the sign, the controller 150 may control the speed of the vehicle to be a predetermined safe speed.

Since the method of confirming the intention of the driver and the method of controlling the vehicle such that the vehicle speed reaches the predetermined safe speed, which may be performed by the controller 150, have been described in detail above, a detailed explanation thereof will be omitted here.

In addition, the driver assistance system 100 according to the embodiment of the present disclosure may include an acceleration apparatus 210 configured to accelerate the vehicle, a braking apparatus 220 configured to decelerate or brake the vehicle, a steering apparatus 230 configured to control the driving direction of the vehicle, and a display apparatus 240 configured to display the status of the driver assistance system of the vehicle.

Accordingly, the vehicle may be accelerated or decelerated (braked) by transmitting a control signal from the controller 150 to the acceleration apparatus 210 or the braking apparatus 220, and if necessary, a steering assistance may be performed by transmitting a control signal from the controller 150 to the steering device 230.

In addition, the display apparatus 240 connected with the controller 150 may display a driving situation according to the driver assistance system, or display a warning to the driver if necessary.

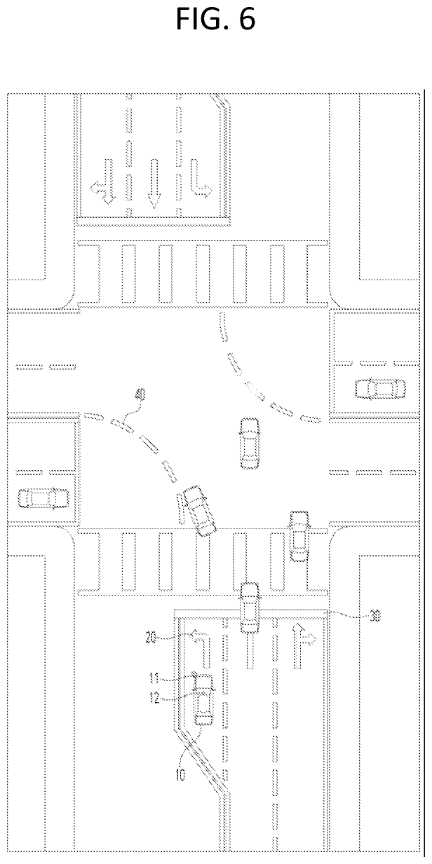

FIG. 6 is a diagram schematically illustrating a road environment when the vehicle enters an intersection in the driver assistance method according to the embodiment of the present disclosure.

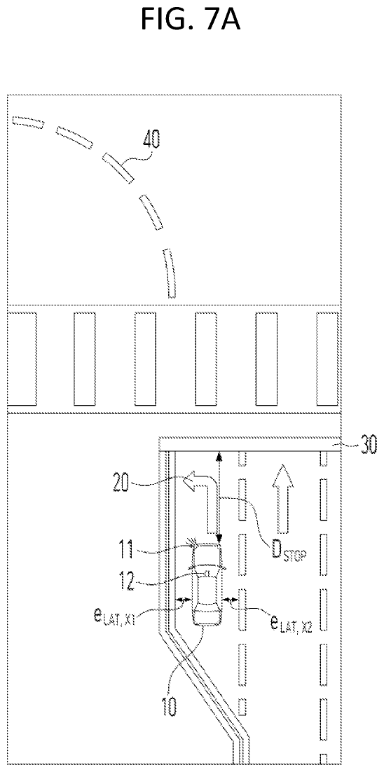

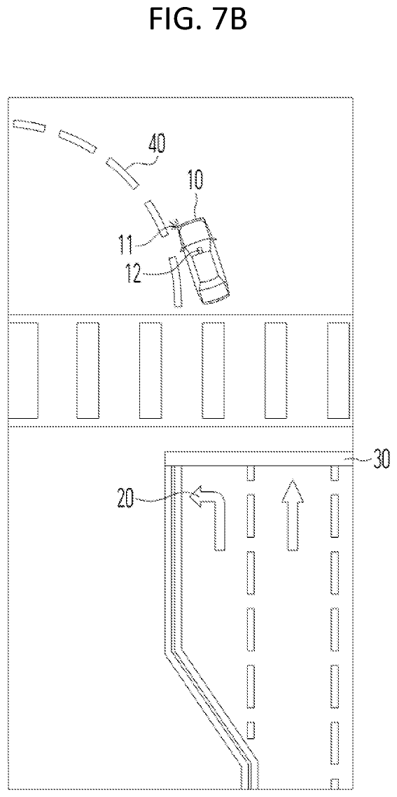

Further, FIG. 7A is a diagram illustrating a state of the vehicle before the vehicle reaches a stop line at an intersection in the driver assistance method according to the embodiment of the present disclosure, and FIG. 7B illustrates a state of the vehicle after the vehicle passes the stop line at the intersection in the driver assistance method according to the embodiment of the present disclosure.

As shown in FIG. 6, for example, in a situation where the vehicle 10 is about to enter the intersection, a sign 20 indicating the driving direction of the lane in which the vehicle 10 is driving (the direction in which the vehicle is to drive after entering the intersection) may be marked on the lane. In addition, a stop line 30 serving as a criterion for determining whether to enter the intersection may be positioned in front of the sign 20.

The sign 20 indicating the driving direction of the lane and the stop line 30 may be recognized by, for example, a front camera 12 installed on a windshield of the vehicle 10. In addition, a guidance line 40 guided by the lane on which the vehicle 10 is driving may be marked on the intersection, and the guidance line 40 may also be recognized by the front camera 12.

Looking more specifically at the control when the vehicle 10 enters the intersection referring to FIGS. 7A and 7B, if the vehicle 10 recognizes the sign 20 and the stop line 30 through the front camera 12 corresponding to the recognition device, the controller of the vehicle 10 may determine the intention of the driver whether the driver intends to drive in the same direction as the driving direction indicated by the sign 20 (e.g., the left direction in FIG. 7).

For example, the controller of the vehicle 10 may determine that there is the intention of the driver if the direction of a turn signal light 11 of the vehicle (the left direction in FIG. 7) and the direction indicated by the sign 20 are the same (in the case of FIG. 7).

Additionally, the controller of the vehicle 10 may determine the driver's intention by determining whether the vehicle 10 is driving along the center of the lane prior to entering the intersection. Specifically, it may be determined whether the absolute value of the difference between the values of the left side lateral offset e_{LAT,X1} and the right side lateral offset e_{LAT,X2} of the vehicle 10 on the lane (|e_{LAT,X1}−e_{LAT,X2}|) is less than a predetermined threshold value. If the absolute value is less than the predetermined threshold value, it may be determined that the vehicle will maintain the lane and drive the lane when entering an intersection, and accordingly, the driver's intention to drive in the same direction as the driving direction indicated by the sign 20 may be determined.

If it is determined that there is the intention of the driver as described above, the controller of the vehicle 10 may determine whether the speed V_{EGO} that the vehicle 10 is driving and a predetermined safe speed V_{SAFE} are the same. If they are not the same, the acceleration or deceleration control of the vehicle 10 may be performed for each case of before entering the intersection (FIG. 7A) and after entering the intersection (FIG. 7B).

Specifically, before the vehicle 10 enters the intersection, that is, before the vehicle 10 reaches the stop line 30 (FIG. 7A), as in Equation 1 above, the required acceleration a₁ of the vehicle may be calculated based on the distance D_{STOP} from the vehicle 10 to the stop line 30, and the vehicle 10 may be controlled according to the calculated required acceleration a₁.

In addition, after the vehicle 10 enters the intersection, that is, after the vehicle 10 passes the stop line (FIG. 7B), as in Equation 2 above, the required acceleration a₂ may be calculated based on the difference between the predetermined safe speed V_{SAFE} and the vehicle speed V_{EGO}, and the vehicle may be controlled according to the calculated required acceleration a₂.

By controlling the vehicle according to the determined required acceleration, it is possible to stably drive the vehicle, for example, in case that the vehicle enters the intersection and makes the left turn as shown in FIG. 7.

According to the embodiment of the present disclosure as described above, when the vehicle driving in the cruise control mode enters the intersection, the speed of the ego vehicle may be controlled based on the safe driving speed. Thus, it is possible to provide the driver assistance method and the driver assistance system capable of providing the driver with the sense of stability and reducing the possibility of collision.

Moreover, according to the driver assistance method and driver assistance system according to the embodiments of the present disclosure, the intersection situation can be accurately determined using the front camera. Further, by determining the safe speed of the vehicle to be inversely proportional to the magnitude of the curvature of the guidance line recognized by the front camera, it is possible to drive the vehicle more safely.

On the other hand, according to the prior art, if the vehicle in front is not recognized when entering the intersection in the cruise control mode, the vehicle may be accelerated. Therefore, the driver may operate the brake for safe driving to prevent the acceleration of the vehicle, and thus, the cruise control mode may be released. However, according to the embodiment of the present disclosure, since the speed of the ego vehicle is controlled based on the safe driving speed, it is possible to prevent the unnecessary release of the cruise control mode, thereby providing convenience to the driver.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

10: Vehicle
11: Turn signal light
12: Front camera
20: Sign
30: Stop line
40: guidance line
100: Driver assistance system
110: Processor
120: Recognition device
130: Turn signal light sensor
140: Vehicle speed sensor
150: Controller
210: Acceleration apparatus
220: Braking apparatus
230: Steering apparatus
240: Display apparatus

What is claimed is:

1. A driver assistance method, comprising:
determining a driving state of a vehicle in a cruise control;
recognizing a sign indicating a driving direction of a lane in which the vehicle is driving and a stop line at an intersection;
confirming an intention of a driver to drive in a same direction as the driving direction of the lane indicated by the sign; and
controlling a speed of the vehicle to be a predetermined safe speed if it is confirmed that the driver intends to drive in the same direction as the driving direction of the lane indicated by the sign.

2. The driver assistance method of claim 1, wherein the confirming of the intention of the driver comprises determining whether the driving direction of the lane indicated by the sign indicating the driving direction of the lane matches with a direction of a turn signal light which is on.

3. The driver assistance method of claim 2, wherein the confirming of the intention of the driver further comprises determining whether an absolute value of a difference between a left side lateral offset value of the vehicle and a right side lateral offset value of the vehicle is less than a predetermined threshold value.

4. The driver assistance method of claim 1, wherein the determining of the driving state comprises determining whether the cruise control of the vehicle is activated.

5. The driver assistance method of claim 4, wherein the determining of the driving state further comprises determining whether the speed of the vehicle is equal to or less than a set speed of the cruise control if the cruise control is activated.

6. The driver assistance method of claim 2, wherein if both of left and right turn signal lights of the vehicle are turned on, it is determined that the driving direction indicated by the sign indicating the driving direction of the lane does not match with the direction of the turn signal light which is on.

7. The driver assistance method of claim 1, wherein the sign indicating the driving direction of the lane and the stop line at the intersection are recognized by a front camera installed at the vehicle.

8. The driver assistance method of claim 7, further comprising:
before controlling the speed of the vehicle, recognizing, by the front camera, a curvature of a guidance line guided by the lane in which the vehicle is driving; and
setting the predetermined safe speed to be inversely proportional to the curvature of the guidance line recognized by the front camera.

9. The driver assistance method of claim 1, wherein the controlling of the speed of the vehicle further comprises:
determining whether the speed of the vehicle is equal to the predetermined safe speed; and
if the speed of the vehicle is not equal to the predetermined safe speed, controlling the vehicle according to a required acceleration of the vehicle by determining the required acceleration.

10. The driver assistance method of claim 9, wherein the controlling of the vehicle according to the required acceleration comprises determining the required acceleration of the vehicle based on a distance from the vehicle to the stop line at the intersection until the vehicle reaches the stop line.

11. The driver assistance method of claim 10, wherein the controlling of the vehicle according to the required acceleration comprises determining the required acceleration of the vehicle based on a difference between the predetermined safe speed and the speed of the vehicle after the vehicle passes the stop line at the intersection.

12. A driver assistance system, comprising:
a processor configured to determine a driving state of a vehicle in a cruise control;
a recognition device configured to recognize a sign indicating a driving direction of a lane in which the vehicle is driving and a stop line at an intersection;
a vehicle speed sensor configured to detect a speed of the vehicle on driving; and
a controller configured to confirm an intention of a driver to drive in a same direction as the driving direction of the lane indicated by the sign, and if it is confirmed that the driver intends to drive in the same direction as the driving direction of the lane indicated by the sign, control the speed of the vehicle to be a predetermined safe speed.

13. The driver assistance system of claim 12, wherein the recognition device is a front camera installed at the vehicle.

14. The driver assistance system of claim 12, further comprising a turn signal light sensor configured to detect whether a turn signal light of the vehicle is on,
wherein the controller is configured to receive a detection signal of the turn signal light of the vehicle from the turn signal light sensor, and determine whether the driving direction indicated by the sign indicating the driving direction of the lane matches with the direction of the turn signal light which is on.

15. The driver assistance system of claim 14, wherein if the driving direction indicated by the sign indicating the driving direction of the lane matches with the direction of the turn signal light which is on, the controller is configured to determine whether an absolute value of a difference between a left side lateral offset value of the vehicle and a right side lateral offset value of the vehicle is less than a predetermined threshold value.

16. The driver assistance system of claim 14, wherein if the turn signal light sensor detects that both of the left and right turn signal lights of the vehicle are on, the controller is configured to determine that the driving direction indicated by the sign indicating the driving direction of the lane does not match with the direction of the turn signal light which is on.

17. The driver assistance system of claim 13, wherein the front camera is configured to recognize a curvature of a guidance line guided by the lane in which the vehicle is driving, and the controller is configured to determine the predetermined safe speed to be inversely proportional to a size of the curvature of the guidance line recognized by the front camera.

18. The driver assistance system of claim 12, wherein the controller is configured to determine whether the speed of the vehicle is equal to the predetermined safe speed, and if the speed of the vehicle is not equal to the predetermined safe speed, the controller is configured to control the vehicle according to a required acceleration of the vehicle by determining the required acceleration.

19. The driver assistance system of claim 18, wherein the controller is configured to determine the required acceleration of the vehicle based on a distance from the vehicle to the stop line at the intersection until the vehicle reaches the stop line at the intersection.

20. The driver assistance system of claim 19, wherein the controller is configured to determine the required acceleration of the vehicle based on a difference between the predetermined safe speed and the speed of the vehicle after the vehicle passes the stop line at the intersection.
